(19) United States
(12) Patent Application Publication
(10) Pub. No.: US 2006/0078790 A1
(43) Pub. Date: Apr. 13, 2006

(54) Solid electrolytes based on lithium hafnium phosphate for active metal anode protection

(75) Inventors: Yevgeniy S. Nimon, Danville, CA (US); Lutgard C. De Jonghe, Lafayette, CA (US); Steven J. Visco, Berkeley, CA (US)

Correspondence Address: BEYER WEAVER & THOMAS LLP, P.O. BOX 70250, OAKLAND, CA, 94612-0250, US

(73) Assignee: PolyPlus Battery Company

(21) Appl. No.: 11/245,472

(22) Filed: Oct. 5, 2005

Related U.S. Application Data
(60) Provisional application No. 60/616,325, filed on Oct. 5, 2004.

(51) Int. Cl. H01M 2/16; H01M 2/18

(52) U.S. Cl. 429/137; 429/246; 429/303

(57) ABSTRACT

Active metal electrochemical structure, in particular an active metal negative electrode (anode) protected with an ionically conductive protective architecture incorporating a glassy, ceramic or glass-ceramic solid electrolyte material based on lithium hafnium phosphate, and associated electrochemical devices and methods, provides advantages over conventional structures. The protective architecture prevents the active metal from deleterious reaction with the environment on the other (cathode) side of the architecture, which may include aqueous, air or organic liquid electrolytes and/or electrochemically active materials.

### CROSS-REFERENCE TO RELATED APPLICATIONS

This application claims priority to U.S. Provisional Patent Application No. 60/616,325, filed Oct. 5, 2004, titled SOLID ELECTROLYTES BASED ON LITHIUM HAFNIUM PHOSPHATE FOR ACTIVE METAL ANODE PROTECTION, the disclosure of which is incorporated herein by reference in its entirety and for all purposes.

### BACKGROUND OF THE INVENTION

1. Field of the Invention

The present invention relates generally to active metal electrochemical devices. More particularly, this invention relates to an active metal negative electrode (anode) protected with an ionically conductive protective architecture incorporating a glassy, ceramic or glass-ceramic solid electrolyte material based on lithium hafnium phosphate. This protective architecture prevents the active metal from deleterious reaction with the environment on the other (cathode) side of the architecture, which may include aqueous, air or organic liquid electrolytes and/or electrochemically active materials.

2. Description of Related Art

The low equivalent weight of alkali metals, such as lithium, render them particularly attractive as a battery electrode component. Lithium provides greater energy per volume than the traditional battery standards, nickel and cadmium. Unfortunately, no rechargeable lithium metal batteries have yet succeeded in the market place.

The failure of rechargeable lithium metal batteries is largely due to cell cycling problems. On repeated charge and discharge cycles, lithium “dendrites” gradually grow out from the lithium metal electrode, through the electrolyte, and ultimately contact the positive electrode. This causes an internal short circuit in the battery, rendering the battery unusable after a relatively few cycles. While cycling, lithium electrodes may also grow “mossy” deposits that can dislodge from the negative electrode and thereby reduce the battery's capacity.

To address lithium's poor cycling behavior in liquid electrolyte systems, some researchers have proposed coating the electrolyte facing side of the lithium negative electrode with a “protective layer.” Such protective layer must conduct lithium ions, but at the same time prevent contact between the lithium electrode surface and the bulk electrolyte. Many techniques for applying protective layers have not succeeded.

Some contemplated lithium metal protective layers are formed in situ by reaction between lithium metal and compounds in the cell's electrolyte that contact the lithium. Most of these in situ films are grown by a controlled chemical reaction after the battery is assembled. Generally, such films have a porous morphology allowing some electrolyte to penetrate to the bare lithium metal surface. Thus, they fail to adequately protect the lithium electrode.

Various pre-formed lithium protective layers have been contemplated. For example, U.S. Pat. No. 5,314,765 (issued to Bates on May 24, 1994) describes an ex situ technique for fabricating a lithium electrode containing a thin layer of sputtered lithium phosphorus oxynitride (“LiPON”) or related material. LiPON is a glassy single ion conductor (conducts lithium ion) that has been studied as a potential electrolyte for solid state lithium microbatteries that are fabricated on silicon and used to power integrated circuits (See U.S. Pat. Nos. 5,597,660, 5,567,210, 5,338,625, and 5,512,147, all issued to Bates et al.).

Work in the present applicants' laboratories has developed technology for the use of glassy or amorphous protective layers, such as LiPON, in active metal battery electrodes. (See, for example, U.S. Pat. No. 6,025,094, issued Feb. 15, 2000, U.S. Pat. No. 6,402,795, issued Jun. 11, 2002, U.S. Pat. No. 6,214,061, issued Apr. 10, 2001 and U.S. Pat. No. 6,413,284, issued Jul. 2, 2002, all assigned to PolyPlus Battery Company).

Prior attempts to use lithium anodes in corrosive environments have met with difficulty. Lithium anodes in aqueous environments, for example, relied either on the use of very basic conditions such as use of concentrated aqueous KOH to slow down the corrosion of the Li electrode, or on the use of polymeric coatings on the Li electrode to impede the diffusion of water to the Li electrode surface. In all cases however, there was substantial reaction of the alkali metal electrode with water. In this regard, the prior art teaches that the use of aqueous cathodes or electrolytes with Li-metal anodes is not possible since the breakdown voltage for water is about 1.2 V and a Li/water cell can have a voltage of about 3.0 V. Direct contact between lithium metal and aqueous solutions results in violent parasitic chemical reaction and corrosion of the lithium electrode for no useful purpose. Thus, the focus of research in the lithium metal battery field has been squarely on the development of effective non-aqueous (mostly organic) electrolyte systems.

### SUMMARY OF THE INVENTION

The present invention relates generally to active metal electrochemical structures, in particular an active metal negative electrode (anode) protected with an ionically conductive protective architecture incorporating a glassy, ceramic or glass-ceramic solid electrolyte material based on lithium hafnium phosphate, and associated electrochemical structures and methods. This protective architecture prevents the active metal from deleterious reaction with the environment on the other (cathode) side of the architecture, which may include aqueous, air or organic liquid electrolytes and/or electrochemically active materials.

The architecture includes an active metal (e.g., lithium) ion conductive impervious component comprising a glassy, ceramic or glass-ceramic solid electrolyte material based on lithium hafnium phosphate that is compatible with active metal corrosive environments, separated from an anode active material (e.g., alkali metals, such as lithium), active metal intercalation (e.g., lithium-carbon, carbon) and active metal alloys (e.g., lithium-tin) alloys or alloying metals (e.g., tin) by another component that is chemically compatible with the active metal. This protective architecture prevents the active metal from deleterious reaction with the environment on the other (cathode) side of the impervious layer, which may include aqueous, air or organic liquid electrolytes and/or electrochemically active materials that are corrosive to the active metal.

In some embodiments, the lithium hafnium phosphate-based solid electrolytes can be, or form part of, the substantially impervious (second) component in a solid state laminate or graded composite ionically conductive protective layer of the sort described in described in commonly assigned U.S. patent application Ser. No.: 10/772,157, filed Feb. 3, 2004; Ser. No. 10/825,587, filed Apr. 14, 2004; and Ser. No. 10/772,228, filed Feb. 3, 2004; incorporated by reference herein in their entirety and for all purposes, which also includes a second active metal ion conducting solid material compatible with active metal (e.g., lithium). Thus, these electrolytes find use in the applications described therein.

In other embodiments, the lithium hafnium phosphate-based solid electrolytes can be, or form part of, the substantially impervious component in a ionically conductive protective interlayer architecture, such as are described in U.S. patent application Ser. No. 10/824,944, filed Apr. 14, 2004, incorporated by reference herein in its entirety and for all purposes, which also includes an active metal ion conducting separator compatible with active metal (e.g., lithium) containing a non-aqueous anolyte, e.g., liquid, solid polymer, or gel electrolyte. Thus, again, these electrolytes find use in the applications described therein as well

In various aspects the invention relates to an electrochemical device structure, comprising: an active metal anode having a first surface and a second surface; and a protective architecture on the first surface of the anode, the architecture having a first component ionically conductive and chemically compatible with the active metal on a side in contact with the active metal anode, and second component substantially impervious, ionically conductive and chemically compatible with active metal corrosive environments on the other side; wherein the architecture comprises a glassy, ceramic or glass-ceramic solid electrolyte material based on lithium hafnium phosphate.

In some aspects of the structure the protective architecture comprises a composite, the composite comprising, a first material in contact with the anode, the first material being ionically conductive and chemically compatible with the active metal; and a second material in contact with the first material, the second material comprising the glassy, ceramic or glass-ceramic solid electrolyte material based on lithium hafnium phosphate and being substantially impervious, ionically conductive and chemically compatible with the first material and active metal corrosive environments; wherein the ionic conductivity of the composite is at least 10⁻⁷ S/cm. The composite may be laminate and graded.

In other aspects of the structure the protective architecture comprises: an ionically conductive protective architecture on a first surface of the anode the architecture comprising, an active metal ion conducting separator layer comprising a non-aqueous anolyte, the separator layer being chemically compatible with the active metal, and in contact with the anode, and a substantially impervious ionically conductive layer, comprising a glassy, ceramic or glass-ceramic solid electrolyte material based on lithium hafnium phosphate, chemically compatible with the separator layer and with aqueous environments, and in contact with the separator layer. Various electrochemical cells, including battery cells, incorporating the protected anodes and structures in accordance with the present invention are also provided.

Other aspects of the invention include:

A protective composite battery separator, comprising: an ionically conductive first material or precursor that is chemically compatible with an active metal and air; and a second material in contact with the first material, the second material comprising a glassy, ceramic or glass-ceramic solid electrolyte material based on lithium hafnium phosphate and being substantially impervious, ionically conductive and chemically compatible with the first material and active metal corrosive environments.

A method of fabricating an electrochemical device structure, the method comprising: providing a protective architecture, the architecture being ionically conductive and chemically compatible with an active metal on a first side, and substantially impervious, ionically conductive and chemically compatible with active metal corrosive environments on the other side, the architecture comprising a glassy, ceramic or glass-ceramic solid electrolyte material based on lithium hafnium phosphate; applying an active metal material to the first side of the composite to form an active metal anode.

These and other aspects of the present invention are described in more detail in the description that follows.

### BRIEF DESCRIPTION OF THE DRAWINGS

FIGS. 1A-C are schematic illustrations of electrochemical structures incorporating an ionically conductive protective architecture in accordance with the present invention.

FIG. 2 is a schematic illustration of a battery cell incorporating an ionically conductive protective architecture in accordance with the present invention.

FIGS. 3A-C illustrate embodiments of battery cells in accordance with the present invention that use a tubular protected anode design.

### DETAILED DESCRIPTION OF SPECIFIC EMBODIMENTS

Reference will now be made in detail to specific embodiments of the invention. Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Introduction

The present invention relates generally to active metal electrochemical structures, in particular an active metal negative electrode (anode) protected with an ionically conductive protective architecture incorporating a glassy, ceramic or glass-ceramic solid electrolyte material based on lithium hafnium phosphate (LiHf₂(PO₄)₃), and associated electrochemical structures, devices (e.g., battery cells) and methods. This protective architecture prevents the active metal from deleterious reaction with the environment on the other (cathode) side of the architecture, which may include aqueous, air or organic liquid electrolytes and/or electrochemically active materials.

The architecture includes an active metal (e.g., lithium) ion conductive impervious component comprising a glassy, ceramic or glass-ceramic solid electrolyte material based on lithium hafnium phosphate that is compatible with active metal corrosive environments, separated from an anode active material (e.g., alkali metals, such as lithium), active metal intercalation (e.g., lithium-carbon, carbon) and active metal alloys (e.g., lithium-tin) alloys or alloying metals (e.g., tin) by a second component that is chemically compatible with the active metal. Fully and partially solid state implementations of the architecture are provided. This protective architecture prevents the active metal from deleterious reaction with the environment on the other (cathode) side of the impervious layer, which may include aqueous, air or organic liquid electrolytes and/or electrochemically active materials that are corrosive to the active metal.

The low equivalent weight of alkali metals, such as lithium, render them particularly attractive as a battery electrode component. Lithium provides greater energy per volume than the traditional battery standards, nickel and cadmium. However, lithium metal or compounds incorporating lithium with a potential near that (e.g., within about a volt) of lithium metal, such as lithium alloy and lithium-ion (lithium intercalation) anode materials, are highly reactive to many potentially attractive electrolyte and cathode materials. Lithium and other active metals are highly reactive in ambient conditions and can benefit from a barrier layer when used as electrodes. Active metals are generally alkali metals such (e.g., lithium, sodium or potassium), alkaline earth metals (e.g., calcium or magnesium), and/or certain transitional metals (e.g., zinc), and/or alloys of two or more of these. The following active metals may be used: alkali metals (e.g., Li, Na, K), alkaline earth metals (e.g., Ca, Mg, Ba), or binary or ternary alkali metal alloys with Ca, Mg, Sn, Ag, Zn, Bi, Al, Cd, Ga, In. Preferred alloys include lithium aluminum alloys, lithium silicon alloys, lithium tin alloys, lithium silver alloys, and sodium lead alloys (e.g., Na₄Pb). A preferred active metal electrode is composed of lithium. In various aspects, this invention relates to active metal (e.g., alkali metals, such as lithium), active metal intercalation (e.g., lithium-carbon, carbon) and active metal alloys (e.g., lithium-tin) alloys or alloying metals (e.g., tin) electrochemical (e.g., electrode) structures and cells (e.g., battery cells).

There are a variety of applications that could benefit from the use of aqueous solutions, including water and water-based electrolytes, air, and other materials corrosive to lithium and other active metals, including organic solvents/electrolytes and ionic liquids, on the cathode side of the cell with an active (e.g., alkali, e.g., lithium) metal or active metal intercalation (e.g., lithium alloy or lithium-ion) anode in a battery cell.

The use of lithium intercalation electrode materials like lithium-carbon and lithium alloy anodes, rather than lithium metal, for the anode can also provide beneficial battery characteristics. First of all, it allows the achievement of prolonged cycle life of the battery without risk of formation of lithium metal dendrites that can grow from the Li surface to the membrane surface causing the membrane's deterioration. Also, the use of lithium-carbon and lithium alloy anodes in some embodiments of the present invention instead of lithium metal anode can significantly improve a battery's safety because it avoids formation of highly reactive “mossy” lithium during cycling.

The present invention describes a protected active metal, alloy or intercalation electrode that enables very high energy density lithium batteries such as those using aqueous electrolytes or other electrolytes that would otherwise adversely react with lithium metal, for example. Examples of such high energy battery couples are lithium-air, lithium-water lithium-metal hydride, lithium-metal oxide, and the lithium alloy and lithium-ion variants of these. The cells of the invention may incorporate additional components in their electrolytes (anolytes and catholytes) to enhance cell safety, and may have a variety of configurations, including planar and tubular/cylindrical.

Protected Anodes

The protective architecture of this invention incorporates a substantially impervious layer of an active metal ion conducting glass, ceramic or glass-ceramic solid electrolyte material based on lithium hafnium phosphate (e.g., a lithium hafnium phosphate-based glass-ceramic (LIC-GC)). Such a material that has a high active metal ion conductivity and stability to aggressive electrolytes that are corrosive to lithium metal, such as aqueous electrolytes. The lithium hafnium phosphate-based materials are substantially impervious, ionically conductive and chemically compatible with aqueous electrolytes or other electrolyte (catholyte) and/or cathode materials that are corrosive to lithium metal, for example. Suitable such materials are substantially gap-free, non-swellable and are inherently ionically conductive. That is, they do not depend on the presence of a liquid electrolyte or other agent for their ionically conductive properties. They also have high ionic conductivity, at least 10⁻⁷ S/cm, generally at least 10⁻⁶ S/cm, for example at least 10⁻⁵ S/cm to 10⁻⁴ S/cm, and as high as 10⁻³ S/cm or higher so that the overall ionic conductivity of the multi-layer protective structure is at least 10⁻⁷ S/cm and as high as 10⁻³ S/cm or higher. The thickness of the layer is preferably about 0.1 to 1000 microns, or, where the ionic conductivity of the layer is about 10⁻⁷ S/cm, about 0.25 to 1 micron, or, where the ionic conductivity of the layer is between about 10⁻⁴ about 10⁻³ S/cm, about 10 to 1000 microns, preferably between 1 and 500 microns, and more preferably between 10 and 100 microns, for example 20 microns.

A limitation in the use of these highly conductive glass, ceramic or glass-ceramic solid electrolyte material based on lithium hafnium phosphate in lithium (or other active metal or active metal intercalation) batteries is their reactivity to lithium metal or compounds incorporating lithium with a potential near that (e.g., within about a volt) of lithium metal.

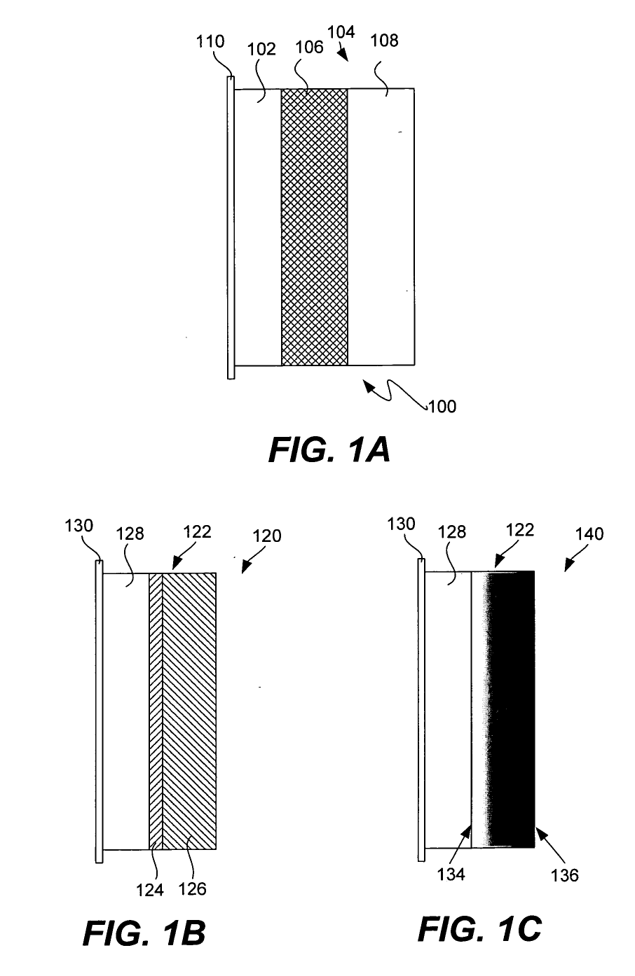

Referring to FIG. 1A, a specific partially solid state embodiment of the present invention is illustrated and described. In these embodiments, the lithium hafnium phosphate-based solid electrolytes can be, or form part of, the substantially impervious component in a ionically conductive protective architecture, such as are described in U.S. patent application Ser. No. 10/824,944, filed Apr. 14, 2004, incorporated by reference herein in its entirety and for all purposes, which also includes an active metal ion conducting separator compatible with active metal (e.g., lithium) containing a non-aqueous anolyte, e.g., liquid, solid polymer, or gel electrolyte. Thus, these electrolytes find use in the applications described therein.

FIG. 1A shows an unscaled depiction of an electrochemical cell structure 100 having an active metal, active metal-ion, active metal alloying metal, or active metal intercalating material anode 102 and an ionically conductive protective architecture 104. The protective architecture 104 has an active metal ion conducting separator layer 106 with a non-aqueous anolyte (sometimes also referred to as a transfer electrolyte) on a surface of the anode 102 and a substantially impervious ionically conductive layer of an active metal ion conducting glass, ceramic or glass-ceramic solid electrolyte material based on lithium hafnium phosphate 108 in contact with the separator layer 106. The separator layer 106 is chemically compatible with the active metal and the substantially impervious layer 108 is chemically compatible with the separator layer 106 and aqueous environments. The structure 100 may optionally include a current collector 110, composed of a suitable conductive metal that does not alloy with or intercalate the active metal. When the active metal is lithium, a suitable current collector material is copper. The current collector 110 can also serve to seal the anode from ambient to prevent deleterious reaction of the active metal with ambient air or moisture.

The separator layer 106 is composed of a semi-permeable membrane impregnated with an organic anolyte. For example, the semi-permeable membrane may be a micro-porous polymer, such as are available from Celgard, Inc. The organic anolyte may be in the liquid or gel phase. For example, the anolyte may include a solvent selected from the group consisting of organic carbonates, ethers, lactones, sulfones, etc, and combinations thereof, such as EC, PC, DEC, DMC, EMC, 1,2-DME or higher glymes, THF, 2MeTHF, sulfolane, and combinations thereof. 1,3-dioxolane may also be used as an anolyte solvent, particularly but not necessarily when used to enhance the safety of a cell incorporating the structure, as described further below. When the anolyte is in the gel phase, gelling agents such as polyvinylidine fluoride (PVdF) compounds, hexafluropropylene-vinylidene fluoride copolymers (PVdf-HFP), polyacrylonitrile compounds, cross-linked polyether compounds, polyalkylene oxide compounds, polyethylene oxide compounds, and combinations and the like may be added to gel the solvents. Suitable anolytes will also, of course, also include active metal salts, such as, in the case of lithium, for example, LiPF₆, LiBF₄, LiAsF₆, LiSO₃CF₃ or LiN(SO₂C₂F₅)₂. One example of a suitable separator layer is 1 M LiPF₆ dissolved in propylene carbonate and impregnated in a Celgard microporous polymer membrane.

The non-aqueous electrolyte interlayer of the protective architecture of the present invention isolates the lithium (for example) electrode from reacting with the active metal ion conducting glass, ceramic or glass-ceramic solid electrolyte material based on lithium hafnium phosphate. The important criteria are that the lithium electrode is stable in the non-aqueous anolyte, the non-aqueous anolyte is sufficiently conductive to Li⁺ ions, the lithium electrode does not directly contact the active metal ion conducting glass, ceramic or glass-ceramic solid electrolyte material based on lithium hafnium phosphate, and the entire assembly allows lithium ions to pass through with high conductivity.

There are a number of advantages of a protective architecture in accordance with this aspect of the present invention. In particular, cell structures incorporating such an architecture may be relatively easily manufactured. In one example, lithium metal is simply placed against a micro-porous separator impregnated with organic liquid or gel electrolyte and with the separator adjacent to a lithium hafnium phosphate-based glass, ceramic or glass ceramic solid electrolyte.

Referring to FIGS. 1B and 1C, alternative solid state structures for a protective architecture in accordance with the present invention are shown. In these embodiments, the lithium hafnium phosphate-based solid electrolytes can be, or form part of, the substantially impervious (second) component in a laminate or graded composite ionically conductive protective layer of the sort described in described in commonly assigned U.S. patent application Ser. No.: 10/772,157, filed Feb. 3, 2004; Ser. No. 10/825,587, filed Apr. 14, 2004; and Ser. No. 10/772,228, filed Feb. 3, 2004; incorporated by reference herein in their entirety and for all purposes, which also includes a second active metal ion conducting solid material compatible with active metal (e.g., lithium). Thus, again, these electrolytes find use in the applications described therein as well.

FIG. 1B illustrates a protected anode structure incorporating a protective laminate composite in accordance with this solid state aspect of the present invention. The structure 120 includes an active metal electrode 128, e.g., lithium, bonded with a current collector 130, e.g., copper, and a protective composite 122. The protective composite 122 is composed of a first layer 124 of a material that is both ionically conductive and chemically compatible with an active metal electrode material, but not chemically compatible with electrolyte or oxidizing materials (e.g., air). For example, the first layer, in contact with the active metal, may be composed, in whole or in part, of active metal nitrides, active metal phosphides or active metal halides. Specific examples include Li₃N, Li₃P, LiI, LiBr, LiCl, LiF and LiPON. The thickness of the first material layer is preferably about 0.1 to 5 microns, or 0.2 to 1 micron, for example about 0.25 micron.

Active metal electrode materials (e.g., lithium) may be applied to these materials, or they may be formed in situ by contacting precursors such as metal nitrides, metal phosphides, metal halides, red phosphorus, iodine and the like with lithium. The in situ formation of the first layer may be by way of conversion of the precursors to a lithiated analog, for example, according to reactions of the following type (using P, Cu₃N, and PbI₂ precursors as examples):

1. 3Li+P=Li₃P (reaction of the precursor to form Li-ion conductor);

2(a). 3Li+Cu₃N=Li₃N+3Cu (reaction to form Li-ion conductor/metal composite);

2(b). 2Li+PbI₂=2 LiI+Pb (reaction to form Li-ion conductor/metal composite).

First layer composites, which may include electronically conductive metal particles, formed as a result of in situ conversions meet the requirements of a first layer material for a protective composite in accordance with the present invention and are therefore within the scope of the invention.

A second layer 126 of the protective composite is composed of a substantially impervious active metal ion conducting glass, ceramic or glass-ceramic solid electrolyte material based on lithium hafnium phosphate.

When the anode structure is incorporated in a battery cell with a water or air (or other active metal corrosive material) cathode, the first layer 124 is adjacent to an active metal (e.g., lithium) anode and the second layer 126 is adjacent to cathode material and its associated aqueous (or other active metal corrosive) electrolyte. As further described below, such battery cells also generally include a porous catalytic electronically conductive support structure to facilitate the cathodic reaction in the cell.

In addition to the protective composite laminates described above, a protective composite in accordance with the present invention may alternatively be compositionally and functionally graded, as illustrated in FIG. 1C. Through the use of appropriate deposition technology such as RF sputter deposition, electron beam deposition, thermal spray deposition, and or plasma spray deposition, it is possible to use multiple sources to lay down a graded film. In this way, the discrete interface between layers of distinct composition and functional character is replaced by a gradual transition of from one layer to the other. The result, as with the discrete layer composites described above, is a bi-functionally compatible ionically conductive composite 140 stable on one side 134 to lithium or other active metal (first material), and on the other side 136 substantially impervious and stable to the cathode, other battery cell components and preferably to ambient atmosphere (second material).

The solid state aspect of the invention may also be embodied as separators independent from anode active materials. These separators having an ionically conductive first material or precursor that is chemically compatible with an active metal and air; and a second material in contact with the first material, the second material comprising a glassy, ceramic or glass-ceramic solid electrolyte material based on lithium hafnium phosphate and being substantially impervious, ionically conductive and chemically compatible with the first material and active metal corrosive environments. They may be laminate or graded in form, as described above.

A suitable active metal compatible layer (first layer) may also include a polymer component to enhance its properties. For example, polymer-iodine complexes like poly(2-vinylpyridine)-iodine (P2VP-I₂), polyethylene-iodine, or tetraalkylammonium-iodine complexes can react with Li to form a LiI-based film having significantly higher ionic conductivity than that for pure LiI.

Also, a suitable first layer may include a material used to facilitate its use, for example, the residue of a thin wetting layer (e.g., Ag) used to prevent reaction between vapor phase lithium (during deposition) and LiPON when LiPON is used as a first layer material. When lithium is evaporated onto this structure, the Ag is converted to Ag—Li and diffuses, at least in part, into the greater mass of deposited lithium, and a protected lithium electrode is created. The thin Ag coating prevents the hot (vapor phase) lithium from contacting and adversely reaction with the LiPON first material layer. After deposition, the solid phase lithium is stable against the LiPON. A multitude of such transient/wetting (e.g., Sn) and first layer material combinations can be used to achieve the desired result.

When the first material layer is a precursor material chemically stable in air, for example Cu₃N or LiPON, the protective composite battery separator may be handled or stored in normal ambient atmospheric conditions without degradation prior to incorporation into a battery cell. When the separator is incorporated into a battery cell, the precursor layer 202 is contacted with an active metal (e.g., lithium) electrode. The precursor reacts with the active metal to form an ionically conductive material that is chemically compatible with the active metal electrode material. The second layer is contacted with an electrolyte to which a cathode and current collector is or has been applied. Alternatively, the second layer acts as the sole electrolyte in the battery cell. In either case, the combination of the two layers in the protective composite protects the active metal electrode and the electrolyte and/or cathode from deleterious reaction with one another.

The layers may be formed using a variety of techniques. These include deposition or evaporation (including e-beam evaporation) or thermal spray techniques such as plasma spray of layers of material, such as Li₃N or an ionically conductive glass (e.g., LiPON). Also, as noted above, the active metal electrode adjacent layer may be formed in situ from the non-deleterious reaction of one or more precursors with the active metal electrode. For example, a Li₃N layer may be formed on a Li anode by contacting Cu₃N with the Li anode surface, or Li₃P may be formed on a Li anode by contacting red phosphorus with the Li anode surface.

Compositions, components and methods of fabrication for or adaptable to the compositions, structures, devices and methods of the present invention are described in U.S. patent application Ser. No. 10/686,189, filed Oct. 14, 2003, and titled IONICALLY CONDUCTIVE COMPOSITES FOR PROTECTION OF ACTIVE METAL ANODES, and U.S. patent application Ser. No. 10/731,771, filed Dec. 5, 2003, and titled IONICALLY CONDUCTIVE COMPOSITES FOR PROTECTION OF ACTIVE METAL ANODES. These applications are incorporated by reference herein in their entirety for all purposes.

Battery Cells

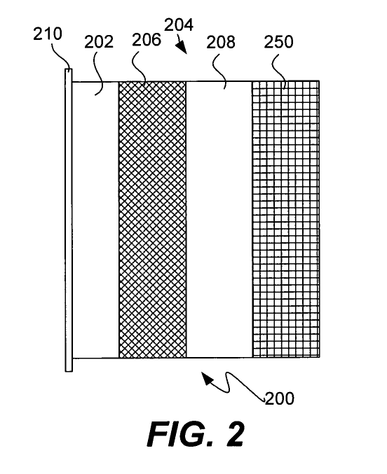

The protective architecture protective is usefully adopted in battery cells. For example, the electrochemical structures 100, 120 or 140 of FIGS. 1A-C can be paired with a cathode system 250 to form a cell 200, as depicted in FIG. 2. The cell 200, includes a current collector 210, and active metal (e.g., lithium) anode 202, a protective architecture 204, generally comprising an active metal (e.g., lithium) ion conductive impervious component comprising a glassy, ceramic or glass-ceramic solid electrolyte material based on lithium hafnium phosphate 208 that is compatible with active metal corrosive environments, separated from the anode by another component 206 that is chemically compatible with the active metal, as described in detail above in various alternatives.

The cathode system 250 includes an electronically conductive component, an ionically conductive component, and an electrochemically active component. The cathode system 250 may have any desired composition and, due to the isolation provided by the protective architecture, is not limited by the anode or, in partially solid state implementations, the anolyte composition. In particular, the cathode system may incorporate components which would otherwise be highly reactive with the anode active metal, such as aqueous materials, including water, aqueous catholytes and air, metal hydride electrodes and metal oxide electrodes.

The cells may be primary or secondary cells.

Cathode Systems

As noted above, the cathode system 250 of a battery cell in accordance with the present invention may have any desired composition and, due to the isolation provided by the protective architecture, is not limited by the anode or, in partially solid state implementations, the anolyte composition. In particular, the cathode system may incorporate components which would otherwise be highly reactive with the anode active metal, such as aqueous materials, including water, aqueous solutions and air, metal hydride electrodes and metal oxide electrodes.

Battery cells of the present invention may include, without limitation, water, aqueous solutions, air electrodes and metal hydride electrodes, such as are described in co-pending application Ser. No. 10/772,157 titled ACTIVE METAL/AQUEOUS ELECTROCHEMICAL CELLS AND SYSTEMS, incorporated herein by reference in its entirety and for all purposes, and metal oxide electrodes, as used, for example, in conventional Li-ion cells (e.g., LiₓCoO₂, LiₓNiO₂, LiₓMn₂O₄, LiFePO₄, AgxV₂O₅, CuxV₂O₅, V₂O₅, V₆O₁₃, FeS₂, TiS₂, MnO₂, CuO, Ag₂CrO₄, MoO₃, CuS and FeS). Active sulfur cathodes (e.g., elemental sulfur or polysulfides) may be used. In some embodiments, a cathode is selected to provide a cell voltage of from about 2 to 5 Volts.

The effective isolation between anode and cathode achieved by the protective architecture of the present invention also enables a great degree of flexibility in the choice of catholyte systems, in particular aqueous systems, but also non-aqueous systems. Since the protected anode is completely decoupled from the catholyte, so that catholyte compatibility with the anode is no longer an issue, solvents and salts which are not kinetically stable to Li can be used.

For cells using water as an electrochemically active cathode material, a porous electronically conductive support structure can provide the electronically conductive component of the cathode system. An aqueous electrolyte (catholyte) provides ion carriers for transport (conductivity) of Li ions and anions that combine with Li. The electrochemically active component (water) and the ionically conductive component (aqueous ctaholyte) will be intermixed as a single solution, although they are conceptually separate elements of the battery cell. Suitable catholytes for the Li/water battery cell of the invention include any aqueous electrolyte with suitable ionic conductivity. Suitable electrolytes may be acidic, for example, strong acids like HCl, H₂SO₄, H₃PO₄ or weak acids like acetic acid/Li acetate; basic, for example, LiOH; neutral, for example, sea water, LiCl, LiBr, LiI; or amphoteric, for example, NH₄Cl, NH₄Br, etc

The suitability of sea water as an electrolyte enables a battery cell for marine applications with very high energy density. Prior to use, the cell structure is composed of the protected anode and a porous electronically conductive support structure (electronically conductive component of the cathode). When needed, the cell is completed by immersing it in sea water which provides the electrochemically active and ionically conductive components. Since the latter components are provided by the sea water in the environment, they need not transported as part of the battery cell prior to it use (and thus need not be included in the cell's energy density calculation). Such a cell is referred to as an “open” cell since the reaction products on the cathode side are not contained. Such a cell is, therefore, a primary cell.

Secondary Li/water cells are also possible in accordance with the invention. As noted above, such cells are referred to as “closed” cells since the reaction products on the cathode side are contained on the cathode side of the cell to be available to recharge the anode by moving the Li ions back across the protective membrane when the appropriate recharging potential is applied to the cell.

In another embodiment of the invention, ionomers coated on the porous catalytic electronically conductive support reduce or eliminate the need for ionic conductivity in the electrochemically active material.

The electrochemical reaction that occurs in a Li/water cell is a redox reaction in which the electrochemically active cathode material gets reduced. In a Li/water cell, the catalytic electronically conductive support facilitates the redox reaction. As noted above, while not so limited, in a Li/water cell, the cell reaction is believed to be:
Li+H₂O=LiOH+1/2H₂.
The half-cell reactions at the anode and cathode are believed to be:
Anode: Li=Li⁺+e⁻
Cathode: e⁻+H₂O═OH⁻+1/2H₂

Accordingly, the catalyst for the Li/water cathode promotes electron transfer to water, generating hydrogen and hydroxide ion. A common, inexpensive catalyst for this reaction is nickel metal; precious metals like Pt, Pd, Ru, Au, etc. will also work but are more expensive.

Also considered to be within the scope of Li (or other active metal)/water batteries of this invention are batteries with a protected Li anode and an aqueous electrolyte composed of gaseous and/or solid oxidants soluble in water that can be used as active cathode materials (electrochemically active component). Use of water soluble compounds, which are stronger oxidizers than water, can significantly increase battery energy in some applications compared to the lithium/water battery, where during the cell discharge reaction, electrochemical hydrogen evolution takes place at the cathode surface. Examples of such gaseous oxidants are O₂, SO₂ and NO₂. Also, metal nitrites, in particular NaNO₂ and KNO₂ and metal sulfites such as Na₂SO₃ and K₂SO₃ are stronger oxidants than water and can be easily dissolved in large concentrations. Another class of inorganic oxidants soluble in water are peroxides of lithium, sodium and potassium, as well as hydrogen peroxide H₂O₂.

The use of hydrogen peroxide as an oxidant can be especially beneficial. There are at least two ways of utilizing hydrogen peroxide in a battery cell in accordance with the present invention. First of all, chemical decomposition of hydrogen peroxide on the cathode surface leads to production of oxygen gas, which can be used as active cathode material. The second, perhaps more effective way, is based on the direct electroreduction of hydrogen peroxide on the cathode surface. In principal, hydrogen peroxide can be reduced from either basic or acidic solutions. The highest energy density can be achieved for a battery utilizing hydrogen peroxide reduction from acidic solutions. In this case a cell with Li anode yields E⁰=4.82 V (for standard conditions) compared to E⁰=3.05 V for Li/Water couple. However, because of very high reactivity of both acids and hydrogen peroxide to unprotected Li, such cell can be practically realized only for protected Li anode such as in accordance with the present invention.

For cells using air as an electrochemically active cathode material, the air electrochemically active component of these cells includes moisture to provide water for the electrochemical reaction. The cells have an electronically conductive support structure electrically connected with the anode to allow electron transfer to reduce the air cathode active material. The electronically conductive support structure is generally porous to allow fluid (air) flow and either catalytic or treated with a catalyst to catalyze the reduction of the cathode active material. An aqueous electrolyte with suitable ionic conductivity or ionomer is also in contact with the electronically conductive support structure to allow ion transport within the electronically conductive support structure to complete the redox reaction.

The air cathode system includes an electronically conductive component (for example, a porous electronic conductor), an ionically conductive component with at least an aqueous constituent, and air as an electrochemically active component. It may be any suitable air electrode, including those conventionally used in metal (e.g., Zn)/air batteries or low temperature (e.g., PEM) fuel cells. Air cathodes used in metal/air batteries, in particular in Zn/air batteries, are described in many sources including “Handbook of Batteries” (Linden and T. B. Reddy, McGraw-Hill, NY, Third Edition) and are usually composed of several layers including an air diffusion membrane, a hydrophobic Teflon layer, a catalyst layer, and a metal electronically conductive component/current collector, such as a Ni screen. The catalyst layer also includes an ionically conductive component/electrolyte that may be aqueous and/or ionomeric. A typical aqueous electrolyte is composed of KOH dissolved in water. An typical ionomeric electrolyte is composed of a hydrated (water) Li ion conductive polymer such as a per-fluoro-sulfonic acid polymer film (e.g., du Pont NAFION). The air diffusion membrane adjusts the air (oxygen) flow. The hydrophobic layer prevents penetration of the cell's electrolyte into the air-diffusion membrane. This layer usually contains carbon and Teflon particles. The catalyst layer usually contains a high surface area carbon and a catalyst for acceleration of reduction of oxygen gas. Metal oxides, for example MnO₂, are used as the catalysts for oxygen reduction in most of the commercial cathodes. Alternative catalysts include metal macrocycles such as cobalt phthalocyanine, and highly dispersed precious metals such at platinum and platinum/ruthenium alloys. Since the air electrode structure is chemically isolated from the active metal electrode, the chemical composition of the air electrode is not constrained by potential reactivity with the anode active material. This can allow for the design of higher performance air electrodes using materials that would normally attack unprotected metal electrodes.

Another type of active metal/aqueous battery cell incorporating a protected anode and a cathode system with an aqueous component in accordance with the present invention is a lithium (or other active metal)/metal hydride battery. For example, lithium anodes protected with a non-aqueous interlayer architecture as described herein can be discharged and charged in aqueous solutions suitable as electrolytes in a lithium/metal hydride battery. Suitable electrolytes provide a source or protons. Examples include aqueous solutions of halide acids or acidic salts, including chloride or bromide acids or salts, for example HCl, HBr, NH₄C₁ or NH₄Br.

In addition to the aqueous, air, etc., systems noted above, improved performance can be obtained with cathode systems incorporating conventional Li-ion battery cathodes and electrolytes, such as metal oxide cathodes (e.g., LiₓCoO₂, LiₓNiO₂, LiₓMn₂O₄ and LiFePO₄) and the binary, ternary or multicomponent mixtures of alkyl carbonates or their mixtures with ethers as solvents for a Li metal salt (e.g., LiPF₆, LiAsF₆ or LiBF₄); or Li metal battery cathodes (e.g., elemental sulfur or polysulfides) and electrolytes composed of organic carbonates, ethers, glymes, lactones, sulfones, sulfolane, and combinations thereof, such as EC, PC, DEC, DMC, EMC, 1,2-DME, THF, 2MeTHF, and combinations thereof, as described, for example, in U.S. Pat. No. 6,376,123, incorporated herein by reference.

Moreover, the catholyte solution can be composed of only low viscosity solvents, such as ethers like 1,2-dimethoxy ethane (DME), tetrahydrofuran (THF), 2-methyltetrahydrofuran, 1,3-dioxolane (DIOX), 4-methyldioxolane (4-MeDIOX) or organic carbonates like dimethylcarbonate (DMC), ethylmethylcarbonate (EMC), diethylcarbonate (DEC), or their mixtures. Also, super low viscosity ester solvents or co-solvents such as methyl formate and methyl acetate, which are very reactive to unprotected Li, can be used. As is known to those skilled in the art, ionic conductivity and diffusion rates are inversely proportional to viscosity such that all other things being equal, battery performance improves as the viscosity of the solvent decreases. The use of such catholyte solvent systems significantly improves battery performance, in particular discharge and charge characteristics at low temperatures.

Ionic liquids may also be used in catholytes of the present invention. Ionic liquids are organic salts with melting points under 100 degrees, often even lower than room temperature. The most common ionic liquids are imidazolium and pyridinium derivatives, but also phosphonium or tetralkylammonium compounds are also known. Ionic liquids have the desirable attributes of high ionic conductivity, high thermal stability, no measurable vapor pressure, and non-flammability. Representative ionic liquids are 1-Ethyl-3-methylimidazolium tosylate (EMIM-Ts), 1-Butyl-3-methylimidazolium octyl sulfate (BMIM-OctSO4), 1-Ethyl-3-methylimidazolium hexafluorophosphate, and 1-Hexyl-3-methylimidazolium tetrafluoroborate. Although there has been substantial interest in ionic liquids for electrochemical applications such as capacitors and batteries, they are unstable to metallic lithium and lithiated carbon. However, protected lithium anodes as described in this invention are isolated from direct chemical reaction, and consequently lithium metal batteries using ionic liquids are possible as an embodiment of the present invention. Such batteries should be particularly stable at elevated temperatures.

Safety Additives

As a safety measure, the non-aqueous interlayer architecture embodiment of the present invention can incorporate a gelling/polymerizing agent that, when in contact with the reactive electrolyte (for example water), leads to the formation of an impervious polymer on the anode (e.g., lithium) surface. This safety measure is used for the case where the substantially impervious layer of the protective architecture (e.g., a glass or glass-ceramic membrane) cracks or otherwise breaks down and allows the aggressive catholyte to enter and approach the lithium electrode raising the possibility of a violent reaction between the Li anode and aqueous catholyte.

Such a reaction can be prevented by providing in the anolyte a monomer for a polymer that is insoluble or minimally soluble in water, for example dioxolane (Diox) (for example, in an amount of about 5-20% by volume) and in the catholyte a polymerization initiator for the monomer, for example, a protonic acid. A Diox based anolyte may be composed of organic carbonates (EC, PC, DEC, DMC, EMC), ethers (1,2-DME, THF, 2MeTHF, 1,3-dioxolane and others) and their mixtures. Anolyte comprising dioxolane as a main solvent (e.g., 50-100% by volume) and Li salt, in particular, LiAsF₆, LiBF₄, LiSO₃CF₃, LiN(SO₂C₂F₅)₂, is especially attractive. Diox is a good passivating agent for Li surface, and good cycling data for Li metal has been achieved in the Diox based electrolytes (see, e.g., U.S. Pat. No. 5,506,068). In addition to its compatibility with Li metal, Diox in combination with above-mentioned ionic salts forms highly conductive electrolytes. A corresponding aqueous catholyte contains a polymerization initiator for Diox that produces a Diox polymerization product (polydioxolane) that is not or is only minimally soluble in water.

If the membrane breaks down, the catholyte containing the dissolved initiator comes in direct contact with the Diox based anolyte, and polymerization of Diox occurs next to the Li anode surface. Polydioxolane, which is a product of Diox polymerization, has high resistance, so the cell shuts down. In addition, the Polydioxolane layer formed serves as a barrier preventing reaction between the Li surface and the aqueous catholyte. Diox can be polymerized with protonic acids dissolved in the catholyte. Also, the water soluble Lewis acids, in particular benbenzoyl cation, can serve this purpose.

Thus, improvement in cyclability and safety is achieved by the use of a dioxolane (Diox) based anolyte and a catholyte containing a polymerization initiator for Diox.

Active Metal Ion and Alloy Anodes

The invention pertains to batteries and other electrochemical structures having anodes composed of active metals, as described above. A preferred active metal electrode is composed of lithium (Li). Suitable first layers (for solid state implementations) and anolytes (for partially solid state implementations) for these structures and cells are described above.

The invention also pertains to electrochemical structures having active metal ion (e.g., lithium-carbon) or active metal alloy (e.g., Li—Sn) anodes. Some structures may initially have uncharged active metal ion intercalation materials (e.g., carbon) or alloying metals (e.g., tin (Sn)) that are subsequently charged with active metal or active metal ions. While the invention may be applicable to a variety of active metals, it is described herein primarily with reference to lithium, as an example.

Carbon materials commonly used in conventional Li-ion cells, in particular petroleum coke and mesocarbon microbead carbons, can be used as anode materials in Li-ion aqueous battery cells. Lithium alloys comprising one or several of the metals selected from the group including Ca, Mg, Sn, Ag, Zn, Bi, Al, Cd, Ga, In and Sb, preferably Al, Sn or Si, can also be used as anode materials for such a battery. In one particular embodiment the anode comprises Li, Cu and Sn.

In accordance with the partially solid state embodiment of the present invention incorporating a non-aqueous anolyte, the anolyte for can incorporate supporting salts, for example, LiPF₆, LiBF₄, LiAsF₆, LiClO₄, LiSO₃CF₃, LiN(CF₃SO₂)₂ or LiN(SO₂C₂F₅)₂ dissolved in binary or ternary mixtures of non-aqueous solvents, for example, EC, PC, DEC, DMC, EMC, MA, MF, commonly used in conventional Li-ion cells. Gel-polymer electrolytes, for instance electrolytes comprising one of the above mentioned salts, a polymeric binder, such as PVdF, PVdF-HFP copolymer, PAN or PEO, and a plasticizer (solvent) such as EC, PC, DEC, DMC, EMC, THF, 2MeTHF, 1,2-DME and their mixtures, also can be used.

For batteries using these anodes, a suitable cathode structure may be added to the electrochemical structure on the other side of the protective architecture. The architecture enables Li-ion type cells using a number of exotic cathodes such as air, water, metal hydrides or metal oxides. For Li-ion aqueous battery cells, for example, aqueous catholyte can be basic, acidic or neutral and contains Li cations. One example of a suitable aqueous catholyte is 2 M LiCl, 1 M HCl.

During the first charge of the battery with lithium-carbon lithium alloy anode, Li cations are transported from the catholyte through the protective architecture (including the anolyte) to the anode surface where the intercalation process takes place as in conventional Li-ion cells. In one embodiment, the anode is chemically or electrochemically lithiated ex-situ before cell assembly.

Cell Designs

Electrochemical structures and battery cells in accordance with the present invention may have any suitable geometry. For example, planar geometries may be achieved by stacking planar layers of the various components of the structures or cells (anode, interlayer, cathode, etc.) according to known battery cell fabrication techniques that are readily adaptable to the present invention given the description of the structure or cell components provided herein. These stacked layers may be configured as prismatic structures or cells.

Alternatively, the use of tubular glass or glass-ceramic electrolytes with a non-aqueous interlayer architecture allows for the construction of high surface area anodes with low seal area. As opposed to flat-plate design where the seal length increases with cell surface area, tubular construction utilizes an end seal where the length of the tube can be increased to boost surface area while the seal area is invariant. This allows for the construction of high surface area Li/water and Li/air cells that should have correspondingly high power density.

The use of a non-aqueous interlayer architecture (partially solid state embodiment) in accordance with the present invention facilitates construction. An open-ended (with a seal) or close-ended glass or glass-ceramic (i.e., substantially impervious active metal ion conductive solid electrolyte) tube is partially filled with a non-aqueous organic electrolyte (anolyte or transfer electrolyte) as described above, for example such as is typically used in lithium primary batteries A lithium metal rod surrounded by some type of physical separator (e.g., a semi-permeable polymer film such as Celgard, Tonin, polypropylene mesh, etc.) having a current collector is inserted into the tube. A simple epoxy seal, glass-to-metal seal, or other appropriate seal is used to physically isolate the lithium from the environment.

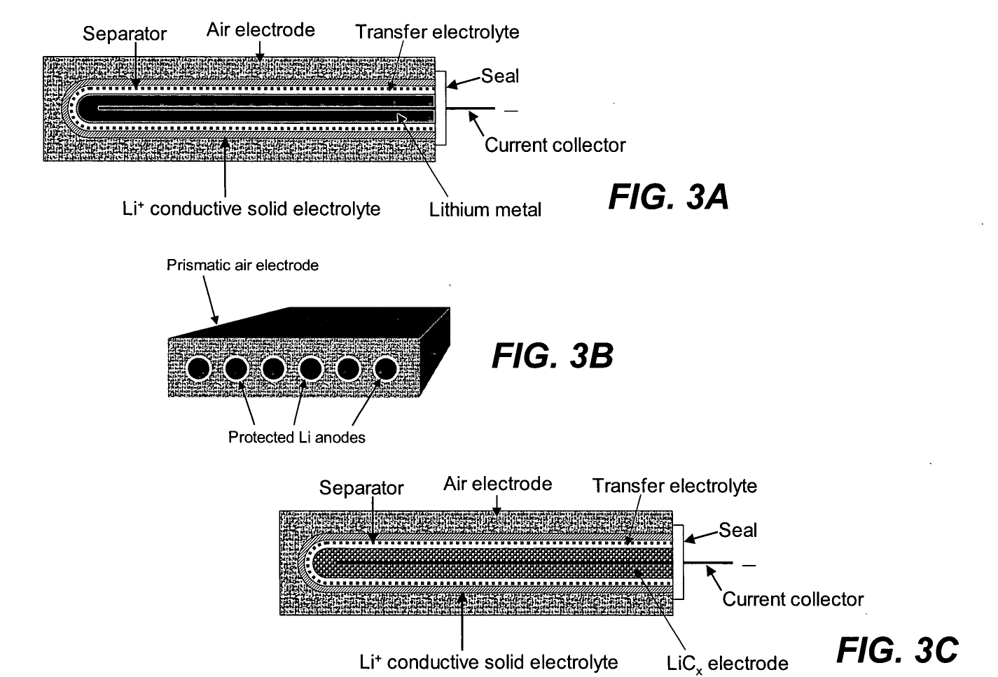

The protected anode can then be inserted in a cylindrical air electrode to make a cylindrical cell, as shown in FIG. 3A. Or an array of anodes might be inserted into a prismatic air electrode, as shown in FIG. 3B.

This technology can also be used to build Li/water, Li/metal hydride or Li/metal oxide cells by substituting the air electrode with suitable aqueous, metal hydride or metal oxide cathode systems, as described herein above.

In addition to the use of lithium metal rods or wires (in capillary tubes), this invention can also be used to isolate a rechargeable LiCₓ anode from aqueous or otherwise corrosive environments. In this case, appropriate anolyte (transfer electrolyte) solvents are used in the tubular anode to form a passive film on the lithiated carbon electrode. This would allow the construction of high surface area Li-ion type cells using a number of exotic cathodes such as air, water, metal hydrides or metal oxides, for example, as shown in FIG. 3C.

These same cell formats can also be constructed using the fully solid state protective architectures in accordance with the present invention.

An alternate cell format incorporating an active metal anode with a protective architecture in accordance with the present invention is a fuel cell, comprising: a renewable active metal anode; a cathode structure comprising a electronically conductive component, an ionically conductive component, and a fluid oxidant; an ionically conductive protective membrane on the first surface of the anode, the membrane comprising, one or more materials, comprising a glassy, ceramic or glass-ceramic solid electrolyte material based on lithium hafnium phosphate, configured to provide a first surface chemically compatible with the active metal of the anode in contact with the anode, and a second surface substantially impervious to and chemically compatible with the cathode structure and in contact with the cathode structure.

Performance. Properties and Advantages

The protected anode architecture of the present invention effectively isolates (de-couples) the anode from ambient and/or cathode, including catholyte (i.e., electrolyte about the cathode) environments, including such environments that are normally highly corrosive to Li or other active metals, and at the same time allows ion transport in and out of these potentially corrosive environments. In this way, a great degree of flexibility is permitted the other components of an electrochemical device, such as a battery cell, made with the architecture. Isolation of the anode from other components of a battery cell or other electrochemical cell in this way allows the use of virtually any solvent, electrolyte and/or cathode material in conjunction with the anode. Also, optimization of electrolytes or cathode-side solvent systems may be done without impacting anode stability or performance.

The electrical properties and crystal structure of lithium hafnium phosphate ceramic electrolytes have been previously studied, however, these materials have never been suggested for use in the protection of active metal anodes. And the preparation and study of glass or glass-ceramic electrolytes based on lithium hafnium phosphate is unknown.

While the present invention is not limited by any particular theory of operation, it is believed that such glassy, ceramic or glass-ceramic solid electrolytes have properties that make them particularly suitable for the protection of Li and other active metal, alloy or intercalation compound based anodes in batteries and other electrochemical structures and cells with aqueous or aggressive (towards active metal anode) non-aqueous electrolytes. There is some debate concerning the exact composition and nature of these electrolyte materials. While not intended to be limiting, the following description is provided as a guide to distinguish these materials from each other to facilitate understanding of the present invention. “Glassy” refers to amorphous materials composed of molecules that are disordered but rigidly bound. For the purposes of the present invention, glassy materials are considered to be solid. “Ceramic” refers to mixtures of crystalline metal oxide particles rigidly bound by sintering. Ceramics are typically polycrystalline. And glass-ceramic refers to a material formed by melting a metal oxide or ceramic composition, quenching it (rapid cooling) sufficiently quickly to obtain an amorphous solid (glass), and then heating the glass to a temperature above the glass transition temperature (T_{g}) and close to the crystallization temperature (T_{c}), and holding the amorphous mass at that temperature for a sufficient amount of time to cause a desired degree of crystallization. For example, some glass-ceramics suitable for use in accordance with the present invention are 90% crystalline. Alternatively, a glass-ceramic can can be formed by melting and quenching a ceramic, and then recrystallizing it by holding the amorphous mass near the crystallization temperature.

The predominant crystalline phase of the ceramic or glass-ceramic solid electrolytes has a NASICON-type rhombohedral structure and high Li⁺-ion conductivity. The conductivity can be enhanced by improving material density and conductive properties of grain boundaries by addition of lithium oxide or other inorganic Li compounds, in particular, Li₃PO₄ and Li₃BO₃ during processing of the ceramic materials. One particularly useful composition according to the present invention is LiHf₂(PO₄)₃+yLi₂O. Other lithium hafnium phosphate-based compounds with high ionic conductivity suitable for anode protection according to current invention include compounds with a general formula of Li₁₊ₓMₓHf₂₋ₓ(PO₄)₃, where M is Cr, In, Fe, Ta, Sc, Lu or Y, wherein 0<X≦0.5.

Advantages of the lithium hafnium phosphate-based glass, ceramic or glass-ceramic electrolytes when used for active metal protection include their processing characteristics, high degree of stability to chemical or electrochemical reduction, and high degree of stability to aqueous environments, including electrolytes. The ceramic or glass ceramic electrolytes based on lithium hafnium phosphate can be used in various formats, in particular as thin plates (or sheets) in the case of prismatic cell design or tubes for tubular cell design. In other embodiments, the ceramic or glass ceramic solid electrolytes based on lithium hafnium phosphate can be prepared in the form of thin coatings on the surface of the sheets or tubes fabricated from other Li-ion conductors. In particular, using a sol-gel method or physical vapor deposition (e.g., e-beam or laser evaporation or sputter deposition) lithium hafnium phosphate-based compounds can be deposited on other ceramics or glass-ceramics having high ionic conductivity and good processing characteristics, but poor stability to aqueous electrolytes, for example ceramics or glass-ceramics based on lithium germanium phosphate.

### EXAMPLES

The following examples provide details illustrating the preparation and properties of a LiHf₂(PO4)₃ solid electrolyte and its advantages when used in accordance with the present invention. These examples are provided to exemplify and more clearly illustrate aspects of the present invention and in no way intended to be limiting.

### Example 1

### Preparation of LiHf₂(PO4)₃ Solid Electrolyte

LiHf₂(PO4)₃ solid electrolyte was prepared using HfO₂, Li₂CO₃, and (NH₄)₃HPO₄ as starting materials. The powders of the starting materials were mixed together using a THINKY mixer and calcined in a platinum crucible at 900° C. for 4 hrs in air. The calcined mass was finely ground using an agate mortar and pestle, ball milled in methanol, dried and sintered at 900° C. for 4 hrs in air. The resulting product was ground into fine powder using ball milling. An x-ray powder diffraction analysis showed that the prepared material was a LiHf₂(PO4)₃ solid electrolyte.

### Example 2

### Chemical Stability of the LiHf₂(PO4)₃ Solid Electrolyte in Seawater

The chemical stability of LiHf₂(PO4)₃ in seawater was tested in order to assess the suitability of this material as a solid electrolyte membrane that can protect a Li anode from aqueous electrolyte in Li/seawater cells. A fine powder of LiHf₂(PO4)₃ was immersed in synthetic sea water (Ricca Corp.) and stored for 1 month at 50° C. under conditions of continuous stirring. After filtration, the liquid phase was analyzed by ICP-MS for concentrations of the elements leached out from LiHf₂(PO4)₃ (Elemental Research Inc., North Vancouver, BC, Canada). Exposure of powdered LiHf₂(PO4)₃ solid electrolyte to a large volume of seawater and elevated temperature during storage the performed test can be viewed as an accelerated test of long term performance. Test data is presented in Table 1 which shows concentrations of various elements released into seawater after LiHf₂(PO₄)₃ exposure for 1 month at 50° C. It is clear that the entire lithium content in LiHf₂(PO4)₃ was released upon exposure to seawater under these conditions. Most likely, this is caused by a well known effect of Li ion exchange with Na ions present in seawater. This result is consistent with the high lithium ion conductivity of LiHf₂(PO4)₃ solid electrolyte. The effect of ion exchange should not adversely affect the performance of a LiHf₂(PO4)₃ protected Li anode under conditions of continuous discharge. As can also be seen from the table, even under the harsh conditions of the experiment, concentrations of dissolved Hf and P are very low, indicating that the LiHf₂(PO4)₃ solid electrolyte is chemically stable in seawater and can be used for protection of a Li anode in a Li/seawater battery.

TABLE 1

| Element | Percent of total content in solid electrolyte |
|---|---|
| Lithium | ˜100% |
| Phosphorus | 0.36% |
| Hafnium | 2.5 · 10⁻⁴% |

### CONCLUSION

Although the foregoing invention has been described in some detail for purposes of clarity of understanding, certain changes and modifications will be apparent to those of skill in the art. In particular, while the invention is primarily described with reference to a lithium metal anode, the anode may also be composed of any active metal, in particular, other alkali metals, such as sodium. It should be noted that there are many alternative ways of implementing both the process and compositions of the present invention. Accordingly, the present embodiments are to be considered as illustrative and not restrictive, and the invention is not to be limited to the details given herein. The following sample claims are representative of aspects of the present invention but should not be considered to be exhaustive.

What is claimed:

1. An electrochemical device structure, comprising:
an active metal anode having a first surface and a second surface; and
a protective architecture on the first surface of the anode, the architecture having a first component ionically conductive and chemically compatible with the active metal on a side in contact with the active metal anode, and second component substantially impervious, ionically conductive and chemically compatible with active metal corrosive environments on the other side;
wherein the architecture comprises a glassy, ceramic or glass-ceramic solid electrolyte material based on lithium hafnium phosphate.

2. The structure of claim 1, wherein the protective architecture comprises a composite, the composite comprising,
a first material in contact with the anode, the first material being ionically conductive and chemically compatible with the active metal; and
a second material in contact with the first material, the second material comprising the glassy, ceramic or glass-ceramic solid electrolyte material based on lithium hafnium phosphate and being substantially impervious, ionically conductive and chemically compatible with the first material and active metal corrosive environments;
wherein the ionic conductivity of the composite is at least 10⁻⁷ S/cm.

3. The structure of claim 1, wherein an active metal anode comprises a material selected from the group consisting of active metal, active metal-ion, active metal alloying metal, and active metal intercalating material.

4. The structure of claim 2, wherein the first material comprises a material selected from the group consisting of active metal nitrides, active metal phosphides, and active metal halides, and active metal phosphorus oxynitride glass.

5. The structure of claim 4, wherein the first material comprises a material selected from the group consisting of Li₃N, Li₃P and LiI, LiBr, LiCl, LiF, and LiPON.

6. The structure of claim 2, wherein the protective composite is a laminate of discrete layers of the first material and the second material.

7. The structure of claim 2, wherein the protective composite comprises a gradual transition between the first material and the second material.

8. The structure of claim 1, wherein the active metal electrode is lithium or a lithium alloy.

9. The structure of claim 1, wherein the protective architecture comprises:
an ionically conductive protective architecture on a first surface of the anode the architecture comprising,
an active metal ion conducting separator layer comprising a non-aqueous anolyte, the separator layer being chemically compatible with the active metal, and in contact with the anode, and
a substantially impervious ionically conductive layer, comprising a glassy, ceramic or glass-ceramic solid electrolyte material based on lithium hafnium phosphate, chemically compatible with the separator layer and with aqueous environments, and in contact with the separator layer.

10. The structure of claim 9, wherein the separator layer comprises a semi-permeable membrane impregnated with a non-aqueous.

11. The structure of claim 10, wherein the semi-permeable membrane is a micro-porous polymer.

12. The structure of claim 11, wherein the anolyte is in the liquid phase.

13. The structure of claim 12, wherein the anolyte comprises a solvent selected from the group consisting of organic carbonates, ethers, esters, formates, lactones, sulfones, sulfolane and combinations thereof.

14. The structure of claim 13, wherein the anolyte comprises a solvent selected from the group consisting of EC, PC, DEC, DMC, EMC, THF, 2MeTHF, 1,2-DME or higher glymes, sufolane, methyl formate, methyl acetate, and combinations thereof and a supporting salt selected from the group consisting of LiPF₆, LiBF₄, LiAsF₆, LiClO₄, LiSO₃CF₃, LiN(CF₃SO₂)₂ and LiN(SO₂C₂F₅)₂.

15. The structure of claim 14, wherein the anolyte further comprises 1,3-dioxolane.

16. The structure of claim 11, wherein the anolyte is in the gel phase.

17. The structure of claim 16, wherein the anolyte comprises a gelling agent selected from the group consisting of PVDF, PVdF-HFP copolymer, PAN, and PEO and mixtures thereof; a plasticizer selected from the group consisting of EC, PC, DEC, DMC, EMC, THF, 2MeTHF, 1,2-DME and mixtures thereof; and a Li salt selected from the group consiting of LiPF₆, LiBF₄, LiAsF₆, LiClO₄, LiSO₃CF₃, LiN(CF₃SO₂)₂ and LiN(SO₂C₂F₅)₂.

18. The structure of claim 1, wherein the substantially impervious ionically conductive component comprises a thin film of the glassy, ceramic or glass-ceramic solid electrolyte material based on lithium hafnium phosphate on another ionically conductive ceramic or glass-ceramic.

19. The structure of claim 18, wherein the other ionically conductive ceramic or glass-ceramic is based on lithium germanium phosphate.

20. The structure of claim 1, wherein the glassy, ceramic or glass-ceramic solid electrolyte material based on lithium hafnium phosphate further comprises lithium oxide or other inorganic Li compounds, in particular, Li₃PO₄ and Li₃BO₃.

21. The structure of claim 1, wherein the glassy, ceramic or glass-ceramic solid electrolyte material based on lithium hafnium phosphate is a LiHf₂(PO₄)₃+yLi₂O glass ceramic.

22. The structure of claim 1, wherein the glassy, ceramic or glass-ceramic solid electrolyte material based on lithium hafnium phosphate has a general formula of Li₁₊ₓMₓHf₂₋ₓ(PO₄)₃, wherein M is Cr, In, Fe, Ta, Sc, Lu or Y, wherein 0<X≦0.5.

23. A battery cell, comprising:
an active metal anode having a first surface and a second surface;
a cathode structure; and
a protective architecture on the first surface of the anode, the architecture being ionically conductive and chemically compatible with the active metal on a side in contact with the active metal anode, and substantially impervious, ionically conductive and chemically compatible with active metal corrosive environments on the other side;
wherein the architecture comprises a glassy, ceramic or glass-ceramic solid electrolyte material based on lithium hafnium phosphate.

24. The cell of claim 23, wherein the protective architecture comprises:
an active metal ion conducting separator layer comprising a non-aqueous anolyte, the separator layer being chemically compatible with the active metal, and in contact with the anode, and
a substantially impervious ionically conductive layer, comprising a glassy, ceramic or glass-ceramic solid electrolyte material based on lithium hafnium phosphate, chemically compatible with the separator layer and the cathode structure, and in contact with the cathode structure.

25. The cell of claim 23, wherein the protective architecture comprises:
a composite, the composite comprising,
a first material in contact with the anode, the first material being ionically conductive and chemically compatible with the active metal; and
a second material in contact with the first material, the second material comprising the glassy, ceramic or glass-ceramic solid electrolyte material based on lithium hafnium phosphate and being substantially impervious, ionically conductive and chemically compatible with the first material and active metal corrosive environments;
wherein the ionic conductivity of the composite is at least 10⁻⁷ S/cm.
